(19) United States
(12) Patent Application Publication
(10) Pub. No.: US 2017/0302663 A1
(43) Pub. Date: Oct. 19, 2017

(54) BLOCK CHAIN BASED IoT DEVICE IDENTITY VERIFICATION AND ANOMALY DETECTION

(71) Applicant: Cisco Technology, Inc., San Jose, CA (US)

(72) Inventors: Nagendra Kumar Nainar, Morrisville, NC (US); Carlos M. Pignataro, Raleigh, NC (US); Rajiv Asati, Morrisville, NC (US)

(21) Appl. No.: 15/098,518

(22) Filed: Apr. 14, 2016

(51) Int. Cl. H04L 29/06; H04L 9/32; H04W 4/00; H04W 60/00

(52) U.S. Cl. CPC H04L 63/0876; H04W 60/00; H04L 9/3247; H04W 4/005

(57) ABSTRACT

In one embodiment, a device in a network receives a network registration request from a particular node. The network registration request comprises information about the particular node. The device causes performance of a validation of the information about the particular node via comparison of the information about the particular node to a distributed block chain that includes information regarding the particular node and one or more other nodes. The device causes an update to the block chain based on the information about the particular node and the validation of the information about the particular node. The device uses the updated block chain to control behavior of the particular node and the one or more other nodes.

### TECHNICAL FIELD

The present disclosure relates generally to computer networks, and, more particularly, to block chain-based device identity verification and anomaly detection in Internet of Things (IoT) and similar networks.

### BACKGROUND

Low-Power and Lossy Networks (LLNs), e.g., sensor networks, have a myriad of applications, such as Smart Grid and Smart Cities. Various challenges are presented with LLNs, such as lossy links, low bandwidth, battery operation, low memory and/or processing capability of a device, etc. Changing environmental conditions may also affect device communications. For example, physical obstructions (e.g., changes in the foliage density of nearby trees, the opening and closing of doors, etc.), changes in interference (e.g., from other wireless networks or devices), propagation characteristics of the media (e.g., temperature or humidity changes, etc.), and the like, also present unique challenges to LLNs. For example, an LLN may be an Internet of Things (IoT) network in which “things,” e.g., uniquely identifiable objects such as sensors and actuators, are interconnected over a computer network.

In IoT and similar networks, mobile nodes may register with different local networks as they move. For example, a person may carry a number of wearable sensors (e.g., heart rate monitor, blood glucose meter, etc.) that connect to different networks as the user travels (e.g., through a community, between different floors of a building, etc.). Each of these sensors and the various networks may have their own registration and authentication mechanisms that can consume multiple resource cycles, depending on how fast the objects are moving.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example communication network;

FIG. 2 illustrates an example network device/node;

FIGS. 3A-3C illustrate examples of a node registering with a network;

FIGS. 4A-4E illustrate examples of node validation using a block chain;

FIGS. 5A-5B illustrate examples of a device using a block chain to authenticate a request;

FIGS. 6A-6C illustrate examples of a device using a block chain to detect anomalies; and

FIG. 7 illustrates an example simplified procedure for using a block chain in a network.

### DESCRIPTION OF EXAMPLE EMBODIMENTS

### Overview

According to one or more embodiments of the disclosure, a device in a network receives a network registration request from a particular node. The network registration request comprises information about the particular node. The device causes performance of a validation of the information about the particular node via comparison of the information about the particular node to a distributed block chain that includes information regarding the particular node and one or more other nodes. The device causes an update to the block chain based on the information about the particular node and the validation of the information about the particular node. The device uses the updated block chain to control behavior of the particular node and the one or more other nodes.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), etc. Generally, size and cost constraints on smart object nodes (e.g., sensors) result in corresponding constraints on resources such as energy, memory, computational speed and bandwidth.

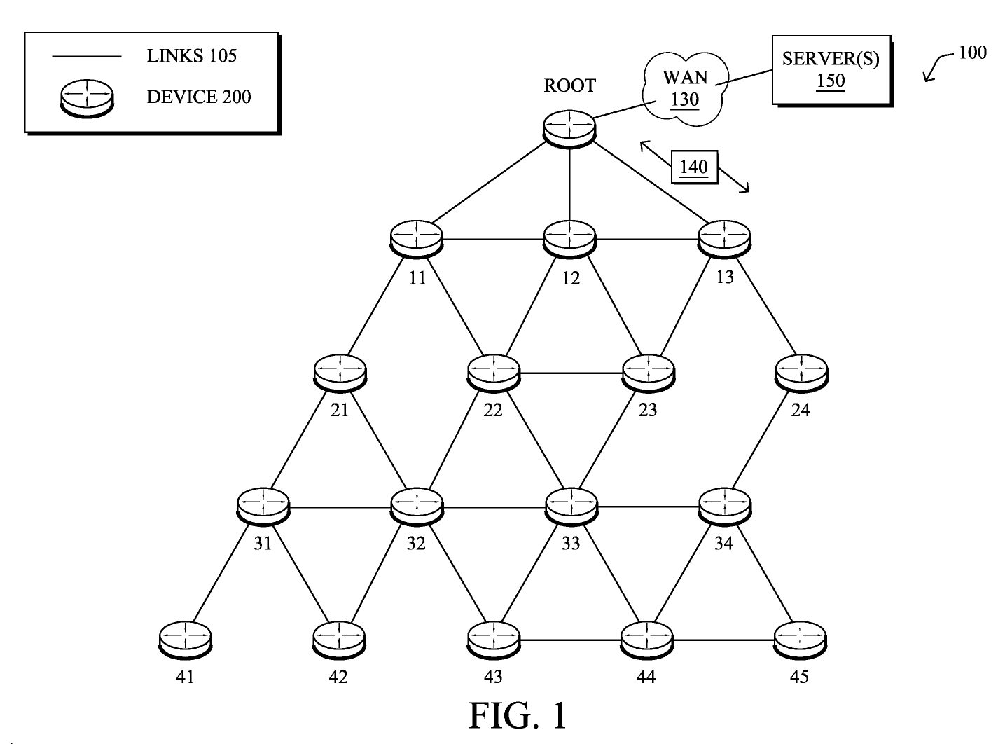

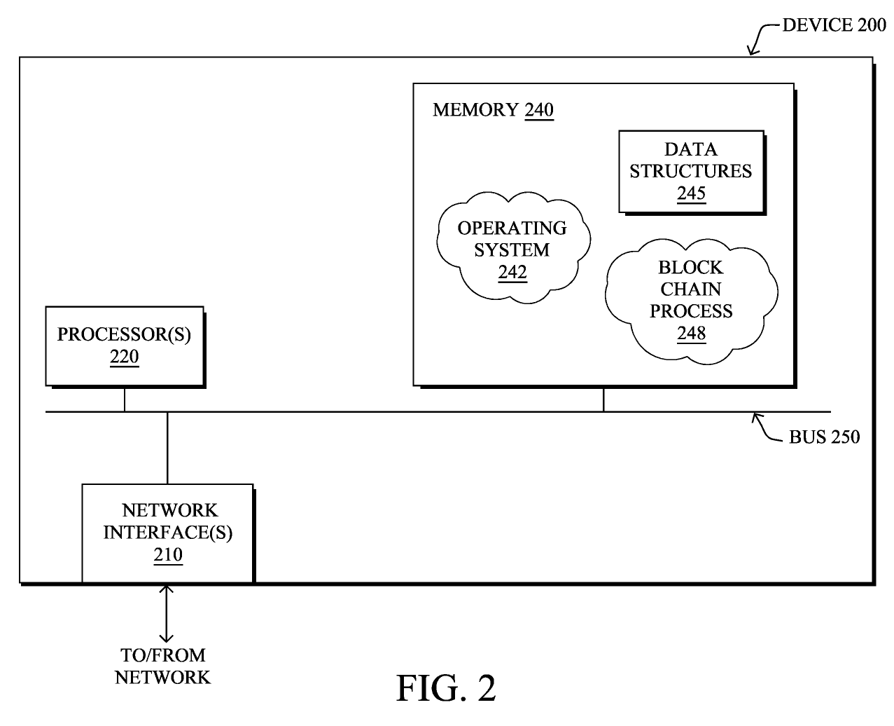

FIG. 1 is a schematic block diagram of an example computer network 100 illustratively comprising nodes/devices 200 (e.g., labeled as shown, “server 150,” “root,” “11,” “12,” . . . “45,” and described in FIG. 2 below) interconnected by various methods of communication. For instance, the links 105 may be wired links or shared media (e.g., wireless links, PLC links, etc.) where certain nodes 200, such as, e.g., routers, sensors, computers, etc., may be in communication with other nodes 200, e.g., based on distance, signal strength, current operational status, location, etc. Those skilled in the art will understand that any number of nodes, devices, links, etc. may be used in the computer network, and that the view shown herein is for simplicity. Also, those skilled in the art will further understand that while the network is shown in a certain orientation, particularly with a “root” node, the network 100 is merely an example illustration that is not meant to limit the disclosure.

Nodes 200 may communicate with any number of external devices, such as server(s) 150 via a network 130, which may be a WAN in some implementations. For example, a particular node 42 may send sensor data to server 150 for further processing, either via a local network or via a WAN. Server(s) 150 may include, but are not limited to, network management system (NMS) devices, supervisory control and data acquisition (SCADA) devices, enterprise resource planning (ERP) servers, other network administration devices, or the like.

Data packets 140 (e.g., traffic and/or messages sent between the devices/nodes) may be exchanged among the nodes/devices of the computer network 100 using predefined network communication protocols such as certain known wired protocols, wireless protocols (e.g., IEEE Std. 802.15.4, WiFi, Bluetooth®, etc.), PLC protocols, or other shared-media protocols where appropriate. In this context, a protocol consists of a set of rules defining how the nodes interact with each other.

FIG. 2 is a schematic block diagram of an example node/device 200 that may be used with one or more embodiments described herein, e.g., as any of the nodes shown in FIG. 1 above. The device may comprise one or more network interfaces 210 (e.g., wired, wireless, PLC, etc.), at least one processor 220, and a memory 240 interconnected by a system bus 250 and powered by a power source (e.g., one or more batteries or other charge storage devices, a power line, etc.).

The network interface(s) 210 contain the mechanical, electrical, and signaling circuitry for communicating data over links 105 coupled to the network 100. The network interfaces may be configured to transmit and/or receive data using a variety of different communication protocols. Note, further, that the nodes may have two different types of network connections 210, e.g., wireless and wired/physical connections, and that the view herein is merely for illustration.

The memory 240 comprises a plurality of storage locations that are addressable by the processor 220 and the network interfaces 210 for storing software programs and data structures associated with the embodiments described herein. Note that certain devices may have limited memory or no memory (e.g., no memory for storage other than for programs/processes operating on the device and associated caches). The processor 220 may comprise hardware elements or hardware logic adapted to execute the software programs and manipulate the data structures 245. An operating system 242, portions of which are typically resident in memory 240 and executed by the processor, functionally organizes the device by, inter alia, invoking operations in support of software processes and/or services executing on the device. These software processes and/or services may comprise a block chain process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

In various embodiments, block chain process 248 may be configured to perform node/device identification and authentication using a distributed block chain that includes information regarding the various nodes/devices in the network. Block chaining first emerged in the realm of cryptocurrencies and generally operates by ensuring a consensus among devices using a peer-to-peer, distributed database. Sometimes also referred to as alternative chaining outside the realm of cryptocurrencies, block chaining provides that each peer device in the system maintain a copy of the entire list of changes in the system. For example, in the case of cryptocurrencies, the distributed database includes a listing of every transaction in which the cryptocurrency is exchanged.

A block chain begins with the creation of a ‘genesis’ block. Each subsequent block then includes a hash of the previous block in the block chain. This has two effects: 1.) modifying an existing block would also require regenerating each block after it, which is highly impractical from a computational standpoint and prevents malicious changes and 2.) the hashing mechanism provides an ordering to the blocks that traces all the way back to the genesis block, allowing devices to track changes in the system. The actual data content of the blocks can also vary. For example, while blocks in a cryptocurrency typically include a listing of currency exchanges/transactions (e.g., Alice transfers $5 to Bob), the data in the blocks is not limited as such and can include any information.

In some cases, blocks in a block chain can also make use of a digital signature mechanism to validate the contents of a block. For example, in the case of cryptocurrencies, a transaction that transfers funds between entities can also include a digital signature and a corresponding public key that can be used to ensure that entity performing the transfer actually has ownership of the funds (e.g., by referencing prior transactions associated with the signer that show the signer as having sufficient funds). In many cases, the signature mechanism uses elliptic curve digital signature algorithm (ECDSA)-based signatures. However, other signature techniques can be used in other implementations.

As noted above, Low-Power and Lossy Networks (LLNs) are a class of network in which both the routers and their interconnections are constrained: LLN routers typically operate with constraints, e.g., processing power, memory, and/or energy (battery), and their interconnections are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point such at the root node to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid, smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

Particularly in the context of the IoT and similar networks, device identity and management is a key building block for a viable end-to-end solution. Depending on the particular use case, a “thing” (e.g., a node) may have to register or authenticate its identity with different service enablers that may use various service-specific procedures.

Block Chain Based IoT Device Identity Verification and Anomaly Detection

The techniques herein provide for the use of a block chain based mechanism that conveys information regarding the identity of nodes and/or other metadata regarding the nodes, to control the behavior of the nodes in the networks. In some aspects, a fog/edge/root device may act as a proxy to update node information in the block chain on behalf of the nodes, so as not to require nodes with constrained resources to perform the updates themselves. In another aspect, any new and unconfirmed information regarding a particular node can be validated against the block chain before updating the block chain, accordingly. In a further aspect, devices in the network can also use the block chain to control the behavior of a node in the network, e.g., by confirming the identity of the node, associating a trust level with the node, performing anomaly detection, and the like.

Specifically, according to one or more embodiments of the disclosure as described in detail below, a device in a network receives a network registration request from a particular node. The network registration request comprises information about the particular node. The device causes performance of a validation of the information about the particular node via comparison of the information about the particular node to a distributed block chain that includes information regarding the particular node and one or more other nodes. The device causes an update to the block chain based on the information about the particular node and the validation of the information about the particular node. The device uses the updated block chain to control behavior of the particular node and the one or more other nodes.

Illustratively, the techniques described herein may be performed by hardware, software, and/or firmware, such as in accordance with the block chain process 248, which may contain computer executable instructions executed by the processor 220 (or independent processor of interfaces 210) to perform functions relating to the techniques described herein. For example, the techniques herein may be treated as extensions to conventional protocols, such as the various wireless communication protocols, and as such, may be processed by similar components understood in the art that execute those protocols, accordingly.

Operationally, the techniques herein leverage the block chain concept to register and update profile and trust information about network nodes (e.g., IoT sensors, etc.). A fog/edge/root device or a stand-alone proxy may sign this information before updating the block chain servers, ensuring a chain of trust. Any validator can then use the corresponding public key to validate the node information and create/update the block chain with the information. This allows devices in the network to use the block chain to quickly identify a given node and use any relevant information in the block chain about the node to control how the node is handled in the network.

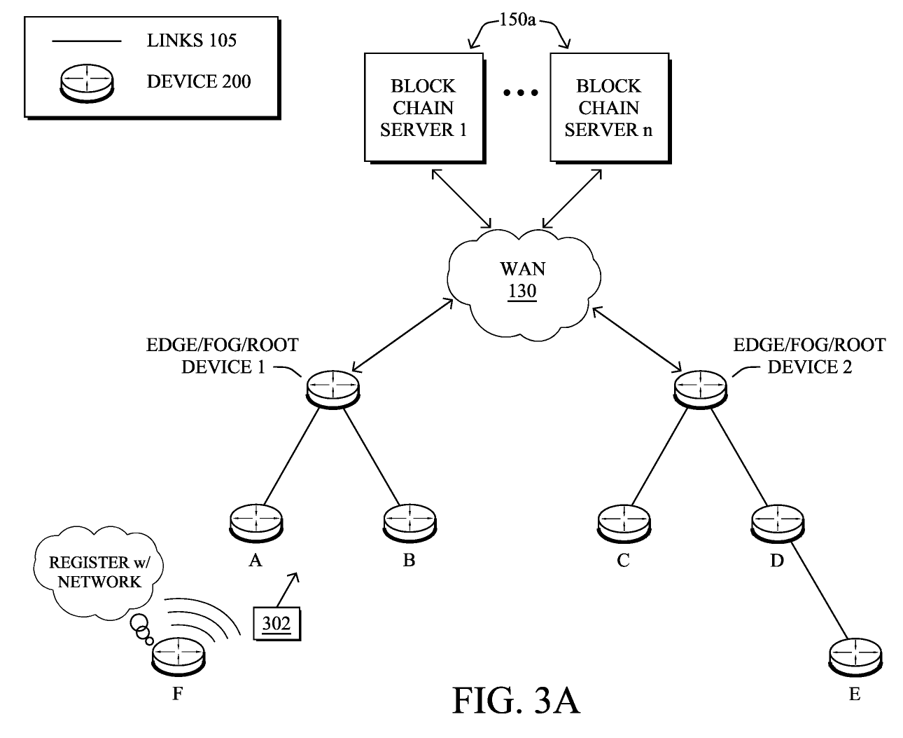

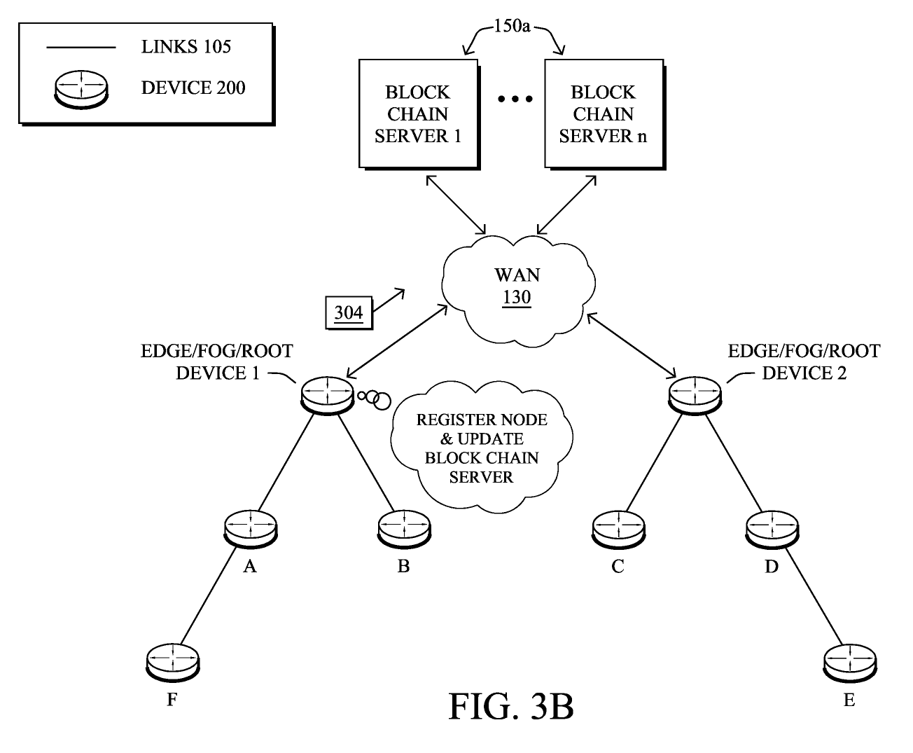

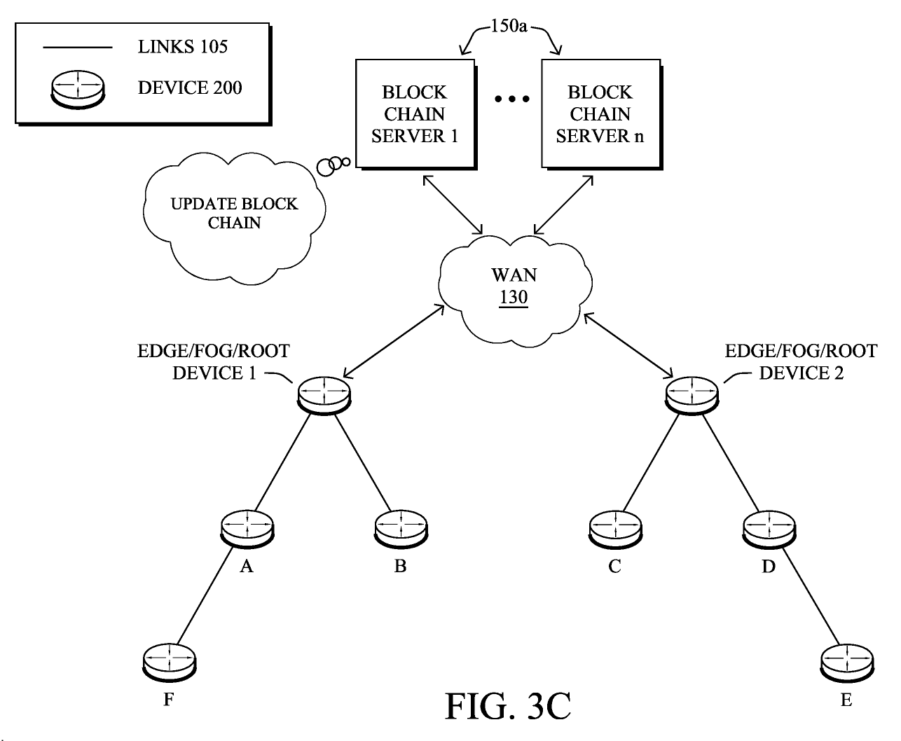

Referring now to FIGS. 3A-3C, examples are shown of a node registering with a network, according to various embodiments. As shown in FIG. 3A, a network may include any number of edge/fog/root devices, such as devices 1-2. In some embodiments, devices 1-2 may be routers (e.g., 6LoWPAN/RPL border routers, etc.) located on the edges of local networks that comprise various IoT nodes. For example, nodes A-B may be registered with edge device 1 forming a first local network and nodes C-E may be registered with edge device 2 forming a second local network.

Also as shown, edge devices 1-2 may be in communication with any number of block chain servers 150a via WAN 130. In some embodiments, block chain servers 150a may be configured to communicate in a peer-to-peer manner and to share block chain information with one another. Generally, the block chain will comprise information about the various nodes that may join the network, such as via registration with edge devices 1-2.

As shown in FIG. 3A, assume that a new node F attempts to register with the local network associated with edge device 1. In such a case, node F may send a registration request 302 that includes identification information for node F and/or any other metadata regarding node F towards edge device 1. For example, in various embodiments, registration request 302 may include any or all of the following:
Entity/Node ID
Entity/Node Type
Access Token
Group ID
Identity Trust Level
Time Stamp
Traffic Profile (Optional)
Optional and/or Vendor-specific fields
   As would be appreciated, the above list is exemplary only and may include any other information regarding a particular node, depending on the use case.

In FIG. 3B, edge router 1 may process registration request 302 from node F and register the transaction with the block chain by sending a notification 304 to block chain servers 150a. In various embodiments, edge device 1 may already be registered and present in the block chain (e.g., as updated via a registrar) with a high trust level (e.g., based on the transaction). Edge device 1 may include any or all of the node information from registration request 302 in notification 304. Further, edge device 1 may also include any other information regarding node F obtained from the local network or independently by edge device 1. In some embodiments, notification 304 may also include one or more digital signatures, for purposes of ensuring that edge device 1 actually sent notification 304, ensuring that the information was originally provided by node F, etc.

Based on notification 304, any number of network devices (e.g., servers 150a, other devices, etc.) may validate the information regarding node F. For example, as shown in FIG. 3C, a block chain server 150a or another device in communication therewith (e.g., an edge device, etc.) may act as a validator for the information included in notification 304. Preferably, a local validator is used by the device seeking validation (e.g., edge device 1, node A, etc.), to restrict public key distribution, but a standalone validator may be used in further implementations.

To process notification 304, the validator may use the public key(s) associated with any digital signatures in notification 304, thereby ensuring that notification 304 was sent by the trusted edge device 1. Then, in turn, the validator may compare the information regarding node F to the block chain, to ensure its validity in view of what is already known about node F in the block chain. Finally, as shown in FIG. 3C, a block chain server 150a may update the block chain to add the details regarding node F to the block chain (e.g., that node F registered with the local network associated with edge device 1, etc.), based on this validation.

Since the updated block chain is distributed among block chain servers 150a, etc., the other nodes/devices in the network also have access to the information about node F. In various embodiments, this distribution of the block chain allows the other nodes/devices to verify the identity of node F (e.g., when node F migrates to another local network, when node F sends a request to another node, etc.), to detect anomalies (e.g., by comparing traffic profile information or other behavioral information regarding node F stored in the block chain to an observed behavior of node F), and to perform other functions using the shared information about node F.

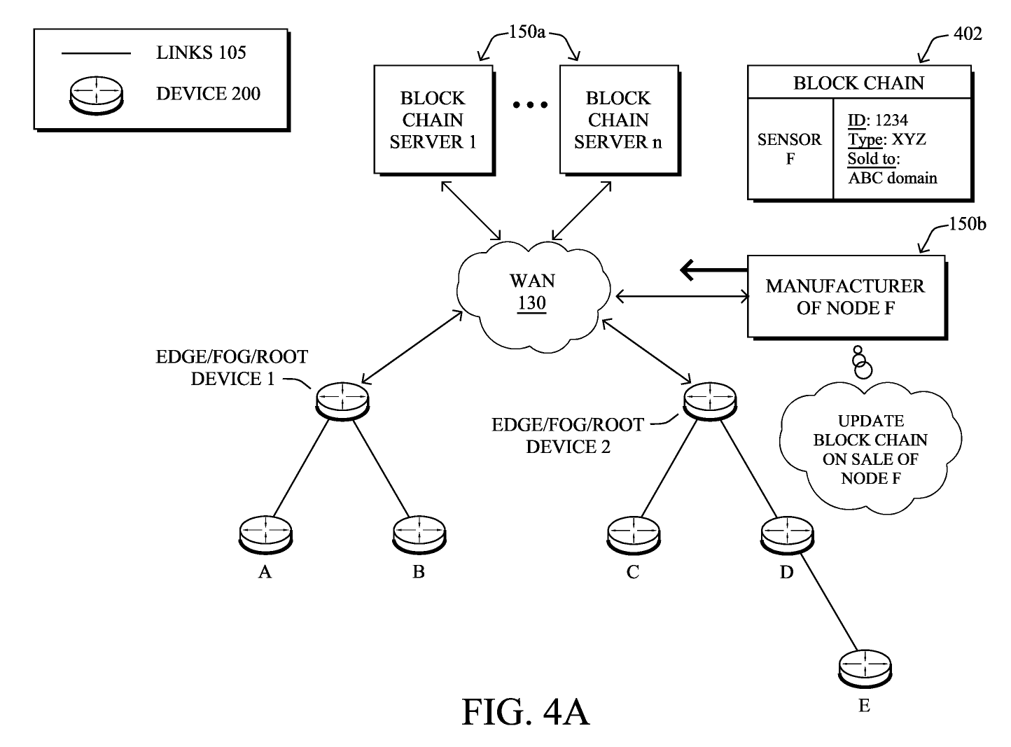

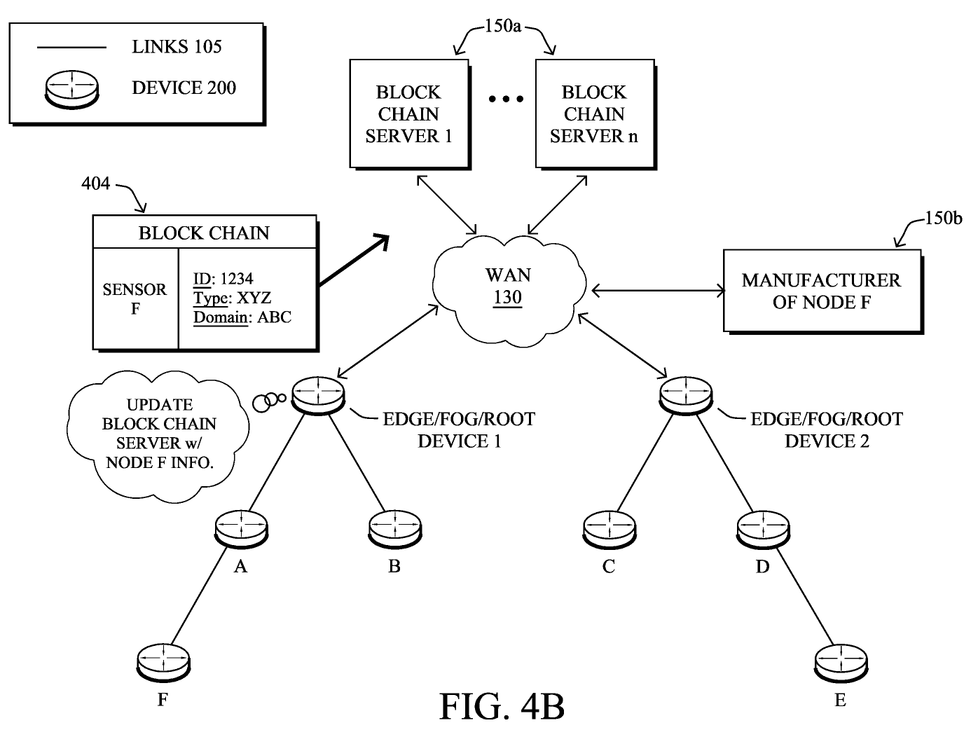

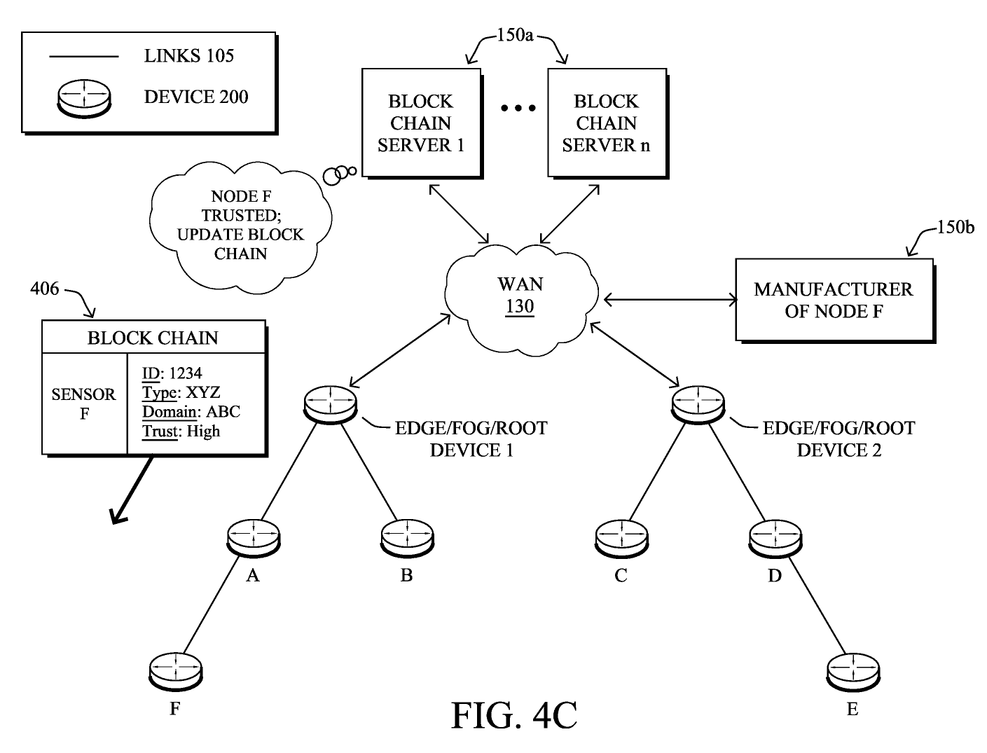

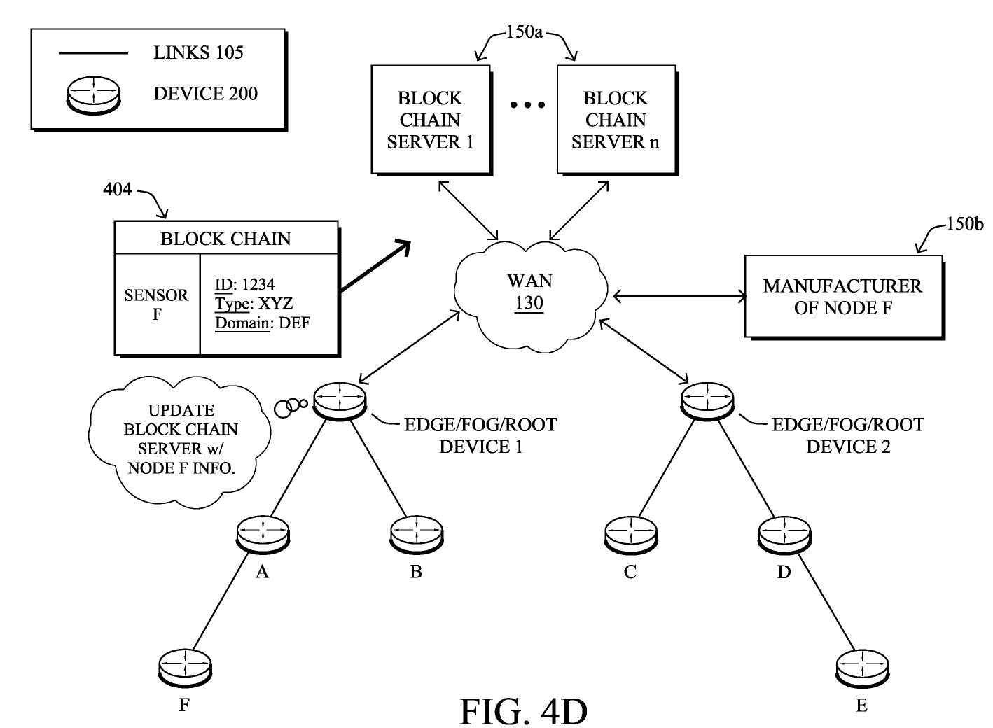

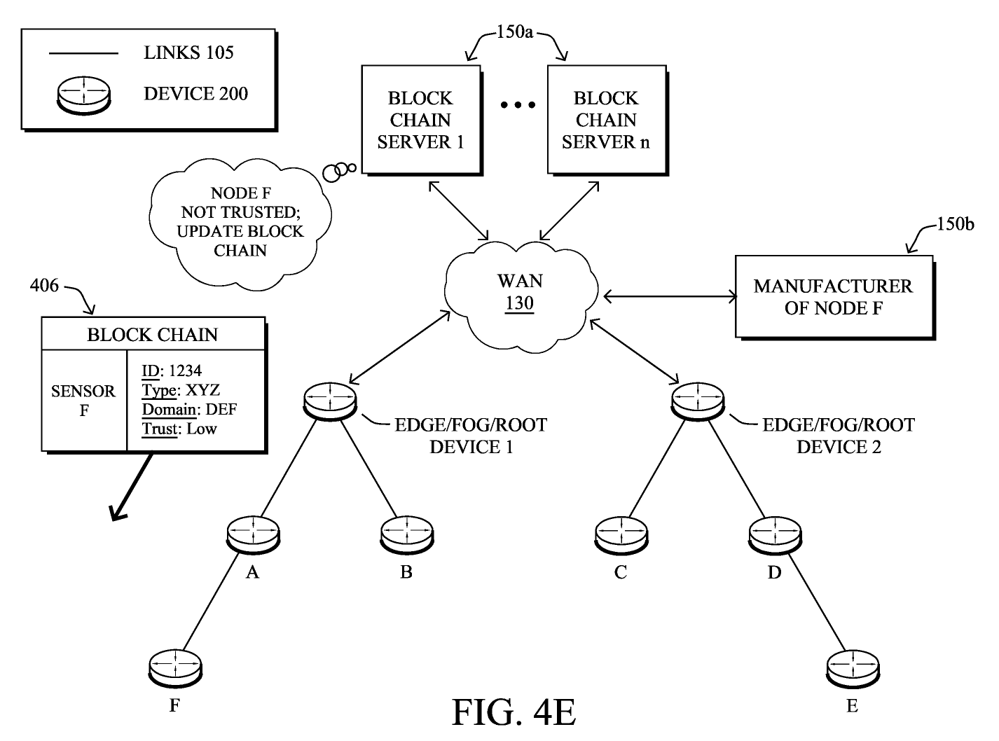

FIGS. 4A-4E illustrate more detailed examples of node validation using a block chain, according to various embodiments. As shown in FIG. 4A, assume that a server 150b is associated with the manufacturer of node F and that server 150b has a high level of trust in the block chain. In some embodiments, server 150b may update the block chain (e.g., block chain 402) to record information regarding node F as part of a sales transaction. For example, server 150b may send a block chain update that records that node F has an ID of 1234, is of node type XYZ, and was sold to the ABC domain. In some embodiments, server 150b may also digitally sign the update using a private key, allowing any validators to verify that the update was indeed sent by server 150b using the corresponding public key of server 150b.

As shown in FIG. 4B, assume that node F later attempts to register with the local domain of edge device 1, similar to the example illustrated in FIGS. 3A-3C. In response to the registration request from node F, edge device 1 may send a notification 404 that includes any information from the registration request and/or any additional information regarding node F, such as the identity of the local domain of edge device 1. Particularly, notification 404 may include information regarding the network registration transaction, to update the block chain. As would be appreciated, edge device 1 can also use the information from node F to validate against any existing details already available in the block chain, such as existing details set by the manufacturer. Once the device is registered to the LAN of device 1, device 1 can then update the information, accordingly.

In FIG. 4C, a validator may compare the information in notification 404 from edge device 1 against the block chain, to determine a level of trust for node F. Recall, for example, that server 150b previously updated the block chain to indicate that the manufacturer of node F sold the node to the operator of domain ABC. In turn, the validator in FIG. 4C may compare the reported domain in notification 404 against the existing block chain, to determine whether the two domains match. If so, the validator may update the block chain with the information in notification 404 and set a high trust level for node F in the block chain.

In FIG. 4D, consider the case in which notification 404 alternatively identifies the domain of edge device 1 as DEF. In response, as shown in FIG. 4E, the validator may determine that there is a mismatch between the reported domain and the existing information in the block chain regarding the node. In particular, based on the block chain, the validator may determine that node F is attempting to register with a domain that differs from the domain previously reported by the manufacturer in the block chain. In turn, the validator may update the block chain with the information about node F, but also assign a low level of trust to the node due to the discrepancy.

In various embodiments, devices in the network can leverage the information stored in the block chain regarding the distributed nodes to control and assess their behaviors. For example, a device may prevent a node with a low level of trust from performing certain functions (e.g., communicating with certain devices, etc.). In one embodiment, a device that receives a request from a particular node may use the block chain to authenticate the requesting node. Based on the results of the authentication, the device may control how the request is processed, if at all. In further cases, the block chain may carry behavioral information regarding a particular node, such as the traffic profile of the node or other observations regarding the node. In some embodiments, devices in the network can then use this behavioral information to assess whether the current behavior of the node is anomalous or otherwise unexpected. More detailed examples of the use of the block chain are provided below.

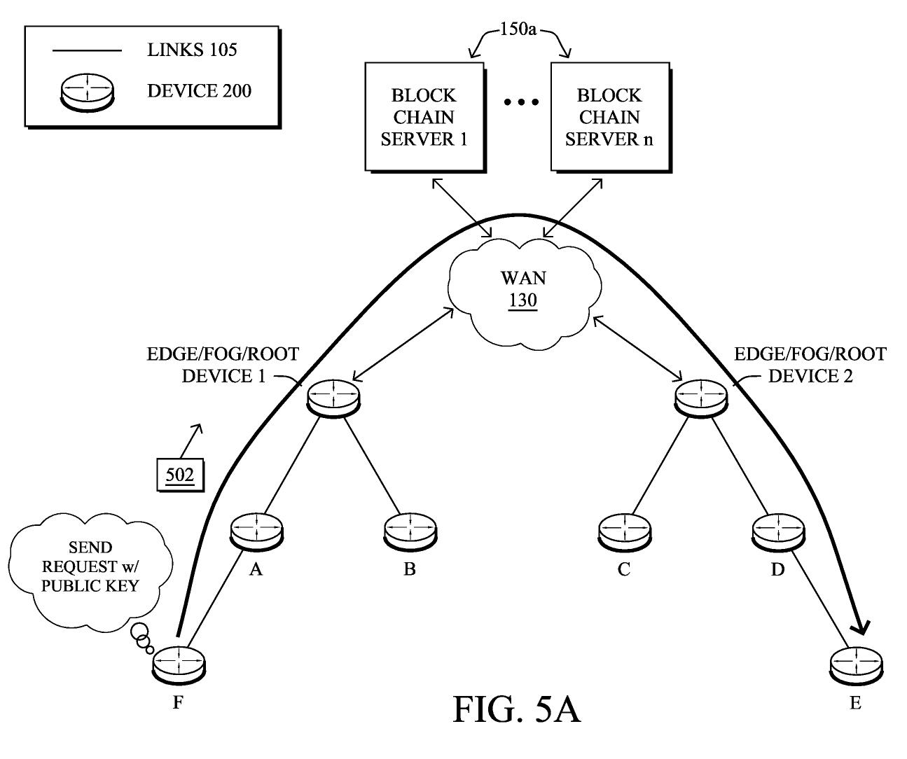

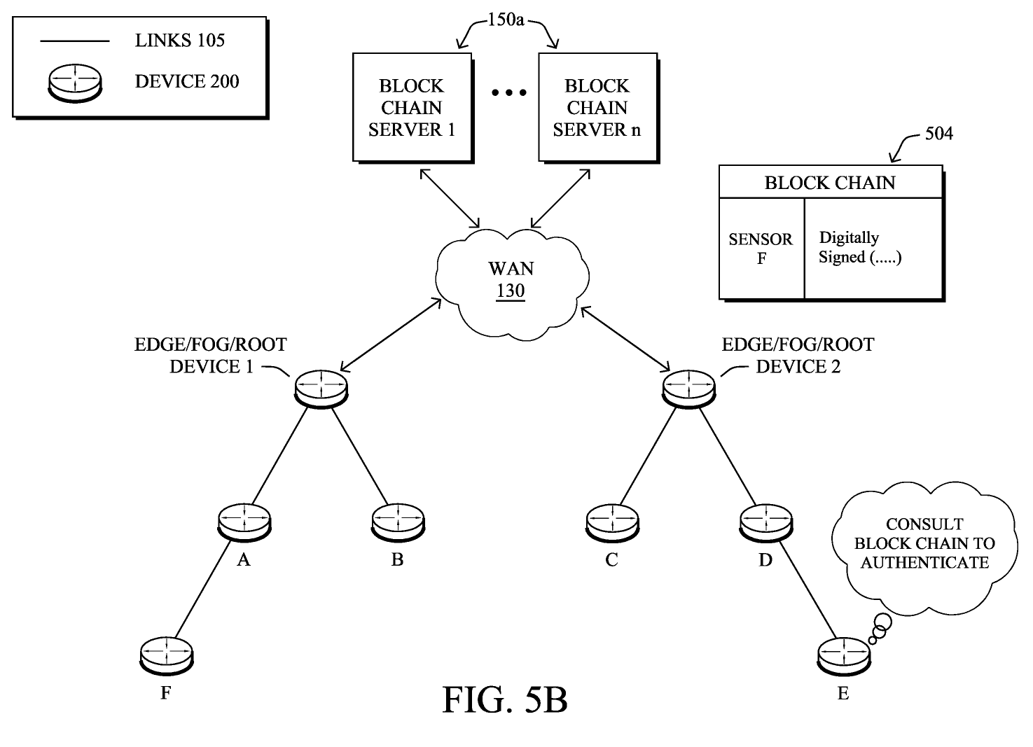

FIGS. 5A-5B illustrate examples of a device using a block chain to authenticate a request, according to various embodiments. In FIG. 5A, assume that node F has registered with the local network associated with edge device 1. While registered in the local network, node F may send a request or other message (e.g., reporting sensor data, etc.) to another node, either in the same network or in a remote network. For example, as shown, assume that node F sends a request 502 to node E in the remote network associated with edge device 2. In various embodiments, as part of sending request 502, node F may also send or otherwise publish its public key. For example, remote node E may challenge node F for its public key, which node F can send via a corresponding application program interface (API)-based response.

As shown in FIG. 5B, node E may use the public key from node F to decipher the information in the block chain regarding node F. Said differently, node E may validate and confirm the identity of node F by using the public key to decipher the digitally signed data regarding node F in block chain 504. If node E is unable to do so, node E may take any number of remediation measures, such as dropping request 502, sending a security alert to a supervisory device, etc. Conversely, if node E is able to authenticate the identity of node F, it may authorize the data session with node F. In some embodiments, node E may further assess the trust level of node F in the block chain and apply a lower weightage to any data from node F.

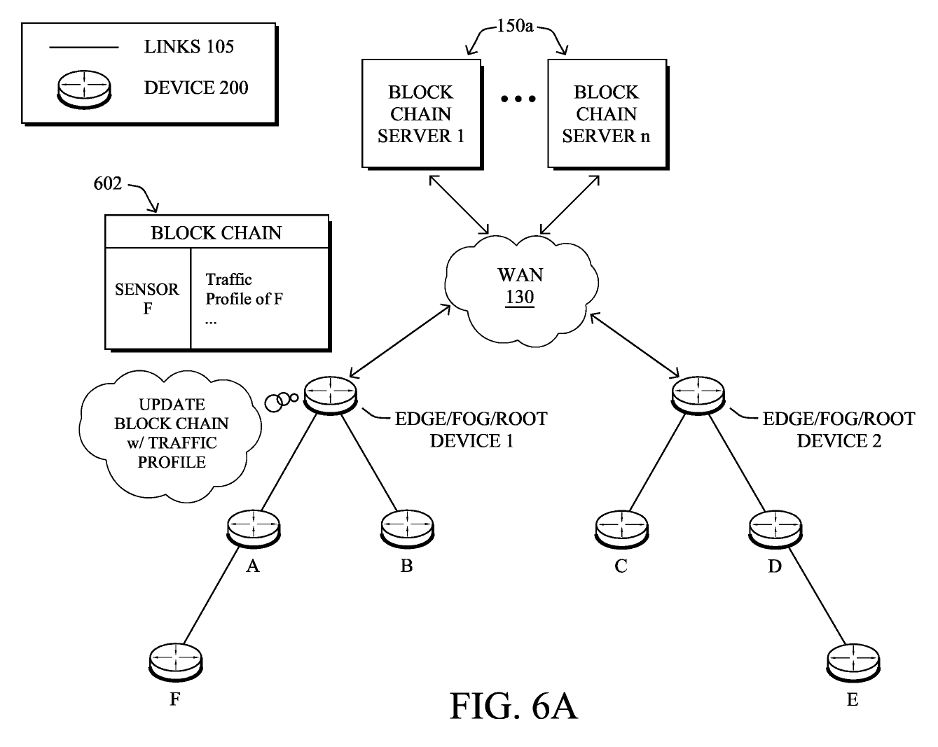

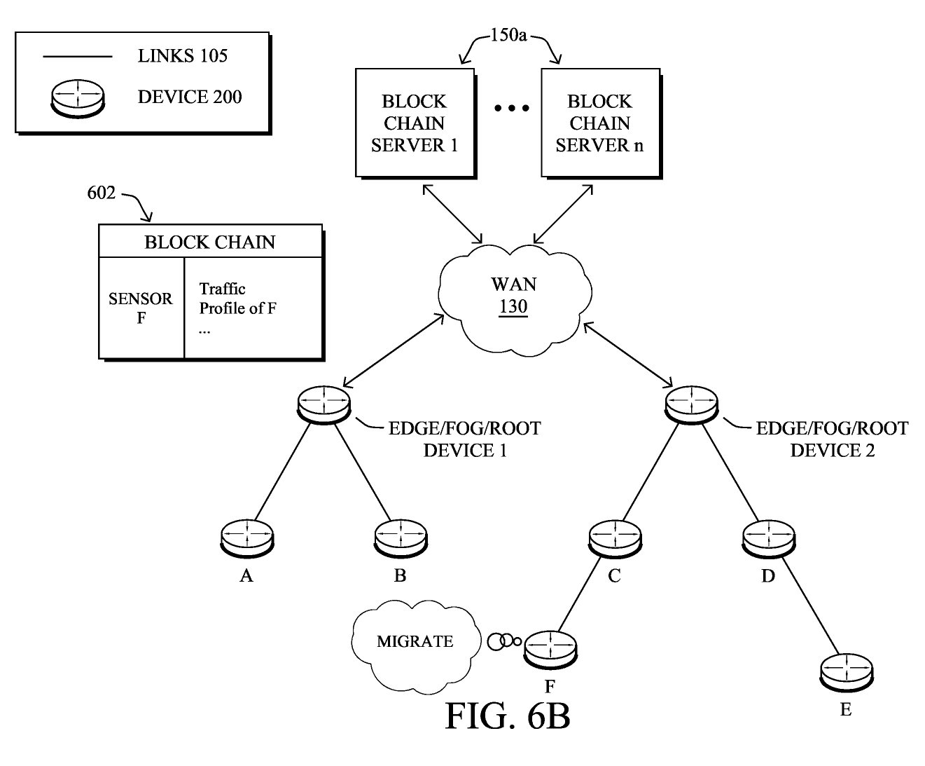

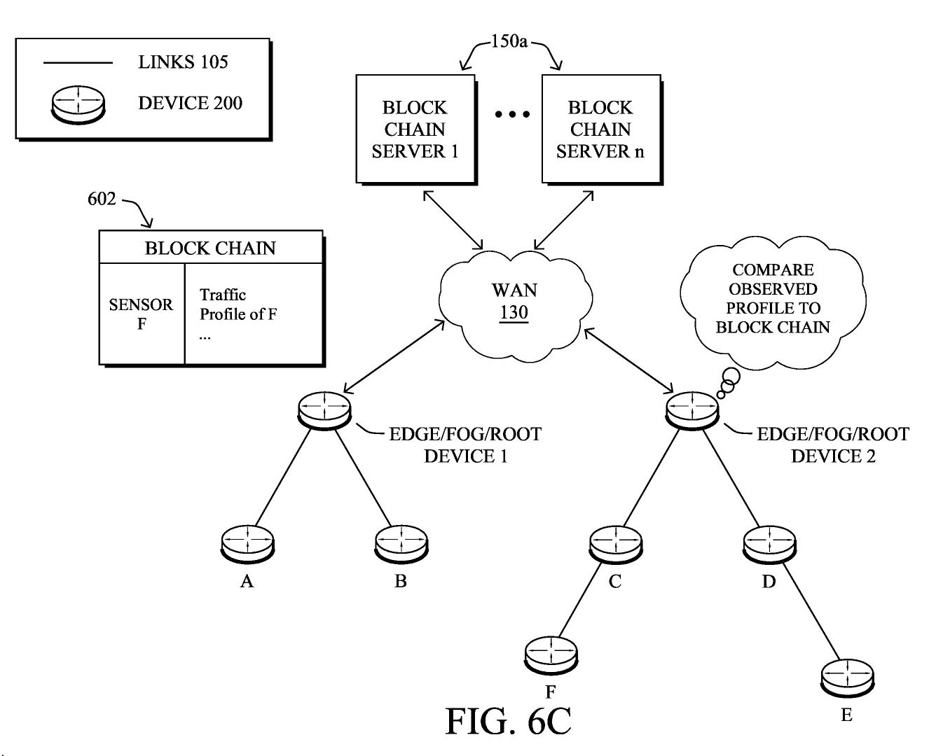

FIGS. 6A-6C illustrate examples of a device using a block chain to detect anomalies, according to various embodiments. As shown in FIG. 6A, assume that node F is registered to the local network of edge device 1. In some embodiments, edge device 1 or another device in the local network may occasionally update the block chain to indicate the observed behavior of node F. For example, edge node 1 may monitor the traffic profile of node F (e.g., when node F sends data, the size of the sent data, the destination of the sent data, etc.). In turn, edge node 1 may initiate a block chain update 602 that includes the observed traffic profile of node F.

In FIG. 6B, assume that node F later migrates to another local network. For example, if node F is a mobile or wearable device, node F may move away from the local network of edge device 1 and into proximity of the local network of edge device 2. In such a case, node F may attempt to register with the local network of edge device 2. As part of this migration, the affected devices may use the block chain to ensure that the node attempting to register with the local domain is indeed node F previously in the local domain of edge device 1 (e.g., by deciphering the digitally signed information in the block chain using the public key of node F, etc.).

In various embodiments, edge device 2 may use any behavioral information in the block chain regarding node F, to determine whether an anomalous condition exists. For example, after node F is registered to the local network of edge device 2, edge device 2 may observe the traffic profile of node F. In turn, edge device 2 may compare the observed traffic profile to that previously recorded in the block chain by edge device 1. If there is a discrepancy in the traffic profiles, edge device 2 may determine that an anomaly exists and take any number of remediation measures (e.g., blocking traffic, sending alerts, etc.). For example, assume that node F is a sensor that sends sensor data every hour to a particular service. If node F suddenly stops sending the sensor data on time, sends it to a different service, etc., edge device 2 can determine that node F is behaving abnormally and take corrective measures based on the traffic profile in the block chain.

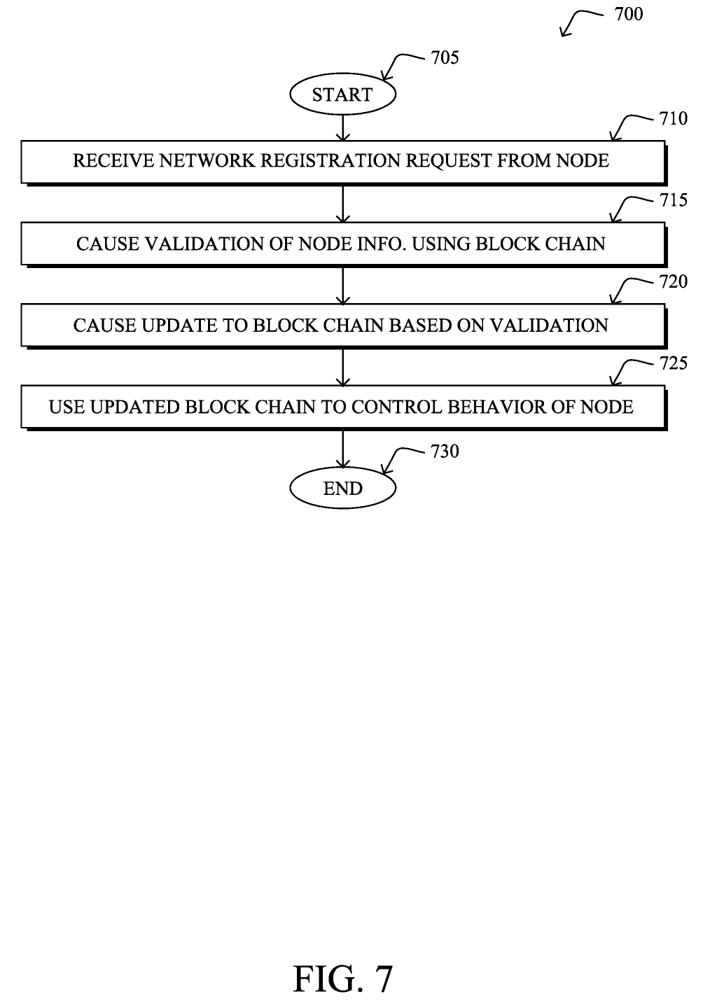

FIG. 7 illustrates an example simplified procedure for using a block chain in a network, in accordance with one or more embodiments described herein. In some embodiments, a specialized computing device (e.g., device 200) may perform procedure 700 by executing stored instructions. For example, an edge/fog/etc. router may perform procedure 700 by executing stored instructions. The procedure 700 may start at step 705, and continues to step 710, where, as described in greater detail above, the device may receive a network registration request from a particular node. For example, a sensor, actuator, other IoT node, etc., may attempt to register with a local network of the device. In various embodiments, the registration request may include information about the particular node such as the type of the node (e.g., type of sensor, etc.), a group identifier, a unique node identifier, an indication of the network to which the node requests registration, or any other information about the particular node. In one embodiment, the node may also apply a digital signature to the request, allowing the device or any other interested device to decipher the contents of the request using the corresponding public key of the node.

At step 715, as detailed above, the device may cause the performance of a validation of the information about the node using a block chain. In various embodiments, the block chain may include node information regarding the particular node and any number of other nodes. For example, in some cases, the manufacturer of the particular node may create an initial entry in the block chain that includes details about the particular node. In turn, validation of the node's information may entail comparing the information from the registration request to any existing information about the node in the block chain. In some embodiments, the device itself may perform the validation. In other embodiments, the device may cause another validation device to perform the validation, such as a block chain server, a devoted validation device, etc.

At step 720, the device may cause an update to the block chain based on the validation in step 715 and the information about the node received in step 710. For example, if the device is an edge router, the router may cause the block chain to be updated to reflect that the particular node is attached to the network of the router. In some cases, a level of trust for the particular node may be included in the update. For example, if certain information about the node does not match that in the block chain, the update to the block chain may indicate a low level of trust for the node.

At step 725, as detailed above, the device may use the updated block chain to control the behavior of the particular node and one or more other nodes. Notably, since the block chain includes identification information for the particular node and potentially additional metadata regarding the node (e.g., the node's traffic profile, etc.), the device can use this information to control how the nodes operate in the network. In some cases, the device may use the block chain to prevent a node from migrating to its local network. In another embodiment, the device may limit or restrict traffic flows of the node based on the block chain. In a further embodiment, the device may use metadata about the node in the block chain to detect anomalous conditions. Procedure 700 then ends at step 730.

It should be noted that while certain steps within procedure 700 may be optional as described above, the steps shown in FIG. 7 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, leverage block chains to update node identity information, as well as potentially other metadata about a node. In some aspects, a fog node may act as a proxy to update the block chain information on behalf of the node, which allows low-power devices to conserve resource. In another aspect, a validator may use the existing information in the block chain about a particular node to validate any new information about the node and update the block chain accordingly. Other nodes in the network can also leverage the block chain information to facilitate movement of the node across local networks, confirming the identity of the node, performing anomaly detection, etc.

While there have been shown and described illustrative embodiments that provide for the use of a block chain to convey device information, it is to be understood that various other adaptations and modifications may be made within the spirit and scope of the embodiments herein. For example, the embodiments have been shown and described herein with relation to certain network configurations. However, the embodiments in their broader sense are not as limited, and may, in fact, be used with other types of shared-media networks and/or protocols (e.g., wireless). In addition, while certain functions are depicted as performed by certain devices, other embodiments provide for these functions to be distributed as desired across one or more devices.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
receiving, at a device in a network, a network registration request from a particular node, wherein the network registration request comprises information about the particular node;
causing, by the device, performance of a validation of the information about the particular node via comparison of the information about the particular node to a distributed block chain that includes information regarding the particular node and one or more other nodes;
causing, by the device, an update to the block chain based on the information about the particular node and the validation of the information about the particular node; and
using, by the device, the updated block chain to control behavior of the particular node and the one or more other nodes.

2. The method as in claim 1, wherein the information about the particular node comprises one or more of: a node type, a group identifier, a unique node identifier, or an indication of the network to which the node requests registration.

3. The method as in claim 1, wherein the update to the block chain comprises a trust level for the particular node based on the validation of the information about the particular node.

4. The method as in claim 3, wherein the comparison of the information about the particular node to the block chain comprises a comparison between the information about the particular node to information regarding the node in the block chain set by a manufacturer of the node.

5. The method as in claim 1, wherein using the updated block chain to control behavior of the particular node and the one or more other nodes comprises:
receiving, at the device, a request from a particular one of the other nodes; and
processing, by the device, the request based in part on a trust level in the updated block chain that is associated with the particular one of the other nodes.

6. The method as in claim 5, wherein the request comprises a public encryption key, the method further comprising:
using, by the device, the public encryption key to authenticate the request by analyzing digitally signed information regarding the particular one of the other nodes in the updated block chain.

7. The method as in claim 1, further comprising:
determining, by the device, a traffic profile of the particular node; and
causing, by the device, the updated block chain to include the traffic profile of the particular node.

8. The method as in claim 1, wherein using, by the device, the updated block chain to control behavior of the particular node and the one or more other nodes comprises:
determining, by the device, a traffic profile of the particular node; and
comparing, by the device, the determined traffic profile to a traffic profile of the particular node in the block chain.

9. The method as in claim 1, wherein the device is a border router in the network.

10. An apparatus, comprising:
one or more network interfaces to communicate with a network;
a processor coupled to the network interfaces and configured to execute one or more processes; and
a memory configured to store a process executable by the processor, the process when executed operable to:
receive a network registration request from a particular node, wherein the network registration request comprises information about the particular node;
cause performance of a validation of the information about the particular node via comparison of the information about the particular node to a distributed block chain that includes information regarding the particular node and one or more other nodes;
cause an update to the block chain based on the information about the particular node and the validation of the information about the particular node; and
use the updated block chain to control behavior of the particular node and the one or more other nodes.

11. The apparatus as in claim 10, wherein the information about the particular node comprises one or more of: a node type, a group identifier, a unique node identifier, or an indication of the network to which the node requests registration.

12. The apparatus as in claim 10, wherein the update to the block chain comprises a trust level for the particular node based on the validation of the information about the particular node.

13. The apparatus as in claim 12, wherein the comparison of the information about the particular node to the block chain comprises a comparison between the information about the particular node to information regarding the node in the block chain set by a manufacturer of the node.

14. The apparatus as in claim 10, wherein the apparatus uses the updated block chain to control behavior of the particular node and the one or more other nodes by:
receiving a request from a particular one of the other nodes; and
processing the request based in part on a trust level in the updated block chain that is associated with the particular one of the other nodes.

15. The method as in claim 14, wherein the request comprises a public encryption key, and wherein the process when executed is further operable to:
use the public encryption key to authenticate the request by analyzing digitally signed information regarding the particular one of the other nodes in the updated block chain.

16. The apparatus as in claim 10, wherein the process when executed is further operable to:
determine a traffic profile of the particular node; and
cause the updated block chain to include the traffic profile of the particular node.

17. The method as in claim 1, wherein the apparatus uses the updated block chain to control behavior of the particular node and the one or more other nodes by:
determining a traffic profile of the particular node; and
comparing the determined traffic profile to a traffic profile of the particular node in the block chain.

18. The apparatus as in claim 10, wherein the apparatus is a border router in the network.

19. A tangible, non-transitory, computer-readable media having software encoded thereon, the software when executed by a processor operable to:
receive a network registration request from a particular node, wherein the network registration request comprises information about the particular node;
cause performance of a validation of the information about the particular node via comparison of the information about the particular node to a distributed block chain that includes information regarding the particular node and one or more other nodes;
cause an update to the block chain based on the information about the particular node and the validation of the information about the particular node; and
use the updated block chain to control behavior of the particular node and the one or more other nodes.

20. The computer-readable media as in claim 19, wherein the software when executed by the processor is further operable to:
perform the validation of the information about the particular node.
